(19) United States
(12) Patent Application Publication
(10) Pub. No.: US 2005/0102258 A1
(43) Pub. Date: May 12, 2005

(54) Saving a file as multiple files

(76) Inventors: Kirk Steven Tecu, Greeley, CO (US); William Robert Haas, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/706,589

(22) Filed: Nov. 12, 2003

(51) Int. Cl. G06F 7/00

(52) U.S. Cl. 707/1

(57) ABSTRACT

A file-saving system is disclosed for saving an active file as multiple new files.

### BACKGROUND

Most computer software applications include file-saving software enabling computer users to save work performed while using the applications. Typically, such file-saving software contains a “Save” operation to save updates of work on an active file. An “active file” is an open file in a workable or changeable state within an open application on a computer or workstation. When an active file is saved, the work performed on the file since the last save operation replaces the most recently saved version of the file, and the active file remains open and can be updated further. After being saved and then closed, the file can be opened again at a later time, enabling the user to pick up from the point at which the last save operation was performed.

A computer user may also choose a “Save As” operation in order to save the active file as another file with a new filename and location. The “Save As” operation does not alter the most recent version of the active file but creates a new file. Generally, a file can be considered as either an image file or a text file, or, alternatively, it may be a hybrid file that includes a combination of image and text data. Using “Save As” in a typical graphics application, the computer user is given the option to store the active image file as a new file having one of several available image file formats, e.g. Joint Photographic Experts Group (JPEG) standard, tag image file format (TIFF), bitmap, graphics interchange format (GIF), etc. With various text applications, the “Save As” function gives the user the option to store the active text file as a new file having one of several available text file formats, e.g. Word Document, Web Page, Rich Text Format, etc. Once a file is saved, the file formats, either image or text, can be identified by observing the extension appended on the end of the filename. For example, the file “picture.tif” may be a TIFF image file having the extension “.tif” at the end of the filename.

In some situations, the user may want to save a file on a portable storage medium and open the file on another computer, or the user may want to transmit the file to another user on another computer. In either case, the saved file can only be opened on another computer if the other computer has compatible software for supporting that file. For this reason, opening a file on a computer other than the computer on which the file was originally saved may result in an error indicating that the software application on the other computer could not open the file because it is not a supported file type. Avoiding such errors involves determining whether the other computer is capable of opening or supporting particular file formats. When it is determined what file formats the other computer is capable of supporting, the user can use the well-known “Save As” operation to save the active file as a new file with an acceptable file format.

Existing systems, however, are time-consuming in situations where the file is to be saved in multiple file formats. In such situations, the user must separately employ the “Save As” function for each file format.

### SUMMARY

File-saving systems, methods, associated computer software, and graphical user interfaces are disclosed. Briefly described, one embodiment is a system comprising means for saving an active file as multiple new files.

### BRIEF DESCRIPTION OF THE DRAWINGS

Many aspects of the embodiments of the present disclosure can be better understood with reference to the following drawings. Like reference numerals designate corresponding parts throughout the several views.

FIG. 1 is a block diagram of an embodiment of a computer that runs an embodiment of a “Save As Multiple Files” (SAMF) system.

FIG. 2A is a block diagram of one of a number of possible embodiments of a SAMF system.

FIG. 2B is a block diagram of a file-parameter-prompting module such as is shown in FIG. 2A.

FIG. 2C is a block diagram of a profile-processing module such as is shown in FIG. 2A.

FIG. 3 is a block diagram of an embodiment of a menu for initiating a SAMF system.

FIG. 4 illustrates an embodiment of a graphical user interface (GUI) of image file parameters generated by the SAMF system of FIG. 2A.

FIG. 5 illustrates another embodiment of a GUI of image file parameters generated by the SAMF system of FIG. 2A.

FIG. 6 illustrates a further embodiment of a GUI of image file parameters generated by the SAMF system of FIG. 2A.

FIG. 7 illustrates yet another embodiment of a GUI of image file parameters generated by the SAMF system of FIG. 2A.

FIG. 8 illustrates an embodiment of a GUI of text file parameters generated by the SAMF system of FIG. 2A.

FIG. 9A illustrates an embodiment of a GUI generated by the profile-processing module of FIG. 2C.

FIG. 9B illustrates an embodiment of another GUI generated by the profile-processing module of FIG. 2C.

### DETAILED DESCRIPTION

To save a file in a different file format, a computer user typically uses the well-known “Save As” operation. If the user wants to save a particular file as multiple files with different file formats, filenames, or locations, then the “Save As” procedure is normally repeated once for every new file. The present disclosure, however, describes embodiments of “Save As Multiple Files” file-saving systems and associated methods that enable a user to save an active file as multiple files in one file-saving operation. In other embodiments, the active file may be saved in the same file format but to multiple locations. Where multiple file formats are employed, the active file can be saved as any number of new files having different file formats, locations, and/or filenames, as well as other selectable file parameter options. Once the user has made all applicable selections during the single operation, embodiments of the file-saving system save the new files substantially simultaneously. In this regard, it should be appreciated that the new files may be saved at the same time or substantially the same time in response to a single save operation. In other words, from the user's perspective, a single save operation enables the new files to be saved.

For example, a user actively working on an image file can save the file as a first new JFIF file in a first folder with a first filename, as a second new JFIF file in a second folder with a second filename, and as a new TIFF file in a third folder with a third filename. In addition, for each new file format, other file parameters, such as compression level, compression algorithm, color level, color translation, resolution, size, quality, operating system format, bit depth, etc. can be selected. In this example, after the user makes the file-saving selections and presses “OK,” embodiments of the file-saving system save the active image file as the three new files according to the selected file parameters. As a result, embodiments of the file-saving system can reduce the user interaction time required to save a file in different file formats or the time required to save a file to multiple locations. Furthermore, embodiments of the file-saving system can reduce the user interaction time required to specify other properties associated with these operations (e.g., file format options, filenames, etc.).

Embodiments of a file-saving system enable a user to store a particular profile of the user's preferences to customize the save process according to the user's needs. Retrieving the profile at a later time further simplifies embodiments of the “Save As Multiple Files” file-saving process. If a user has a need to repeat a particular saving technique for a number of files in which each file is to be saved with particular file formats and locations, then the profile of the file parameter selections can be saved and reused for each file. As an example, if the user wishes to save a number of image files using a particular saving technique, such that each file is to be saved as a new JFIF (JPEG) thumbnail-sized image file and as a full-sized TIFF image file, the user can create a profile based on these selections.

As another example, when considering file parameters based on the needs of others, such as other users, clients, supervisors, etc., the user may also wish to save a profile of another person's selections of file format, file format options, and location. Once these selections are made according to the needs and/or software availability of the other party, a profile of the selections can be stored for later use. The user may then, during a later save operation, select the particular stored profile. In addition, a profile of the latest “Save As Multiple Files” procedure can be saved so that the latest selections can be provided to the user as a default the next time the “Save As Multiple Files” operation is used.

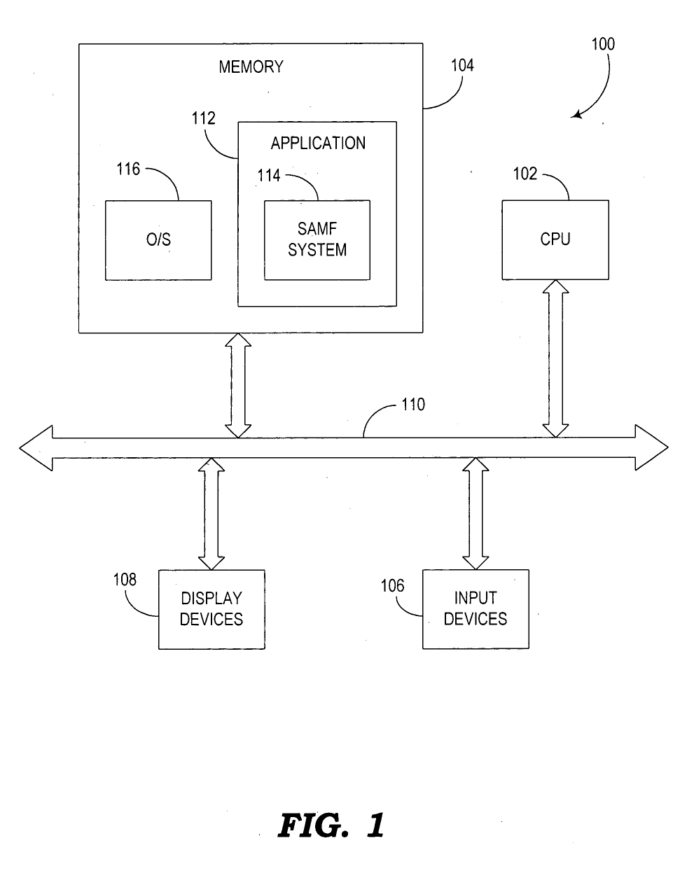

FIG. 1 is a block diagram of an embodiment of a computer 100 on which a “Save As Multiple Files” (SAMF) system may be stored and operated. The SAMF system can be implemented in software, firmware, hardware, or a combination thereof. When implemented in software as an executable program, the SAMF system is executed by the computer 100.

Generally, in terms of hardware architecture, the computer 100 includes a central processing unit (CPU) 102, memory 104, one or more input devices 106, and one or more display devices 108. The CPU 102, memory 104, input devices 106, and display devices 108 are communicatively coupled via a local interface 110. The display devices 108 may include, for example, a monitor, printer, display, or other suitable device for visually or graphically communicating an image to a computer user. The display devices 108 may display one or more graphical user interfaces (GUIs), such as a windows-based graphical screen display.

The software in memory 104 may include one or more separate computer programs or applications 112, each of which comprises an ordered listing of executable instructions for implementing logical functions. In the example of FIG. 1, the software in memory 104 includes a SAMF system 114 and a suitable operating system (O/S) 116. The SAMF system 114 may be configured as a computer program and may be either embedded within or separate from one or more of the applications 112.

When the SAMF system 114 is implemented in software, it can be stored on any computer-readable medium for use by or in connection with any computer related system or method. In the context of this document, a “computer-readable medium” is any electronic, magnetic, electromagnetic, optical, electro-optical, and/or other physical device that can contain, store, communicate, propagate, or transport a computer program for use by a computer-related system or method. The SAMF system 114 can be embodied in any computer-readable medium for use by the computer 100 or other instruction execution system that can fetch and execute the instructions.

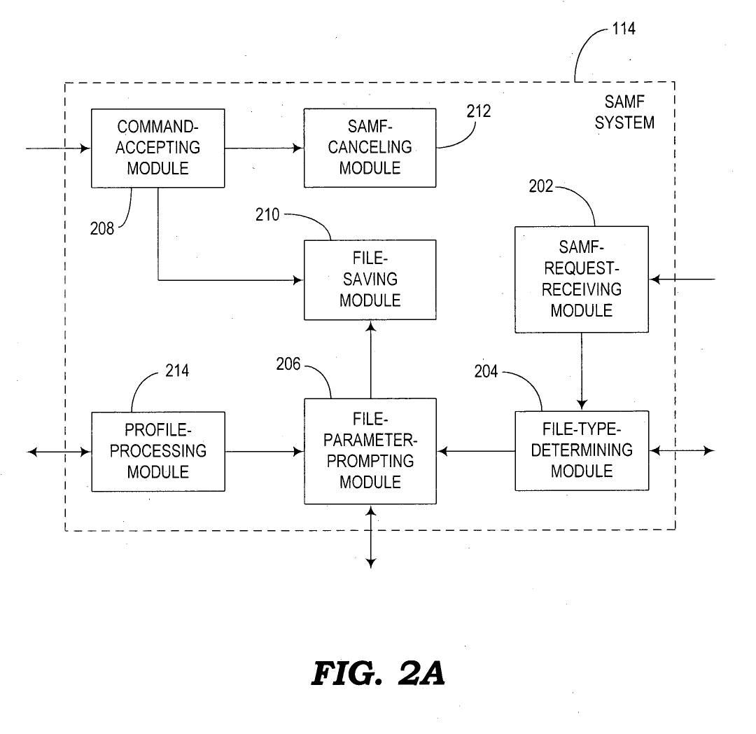

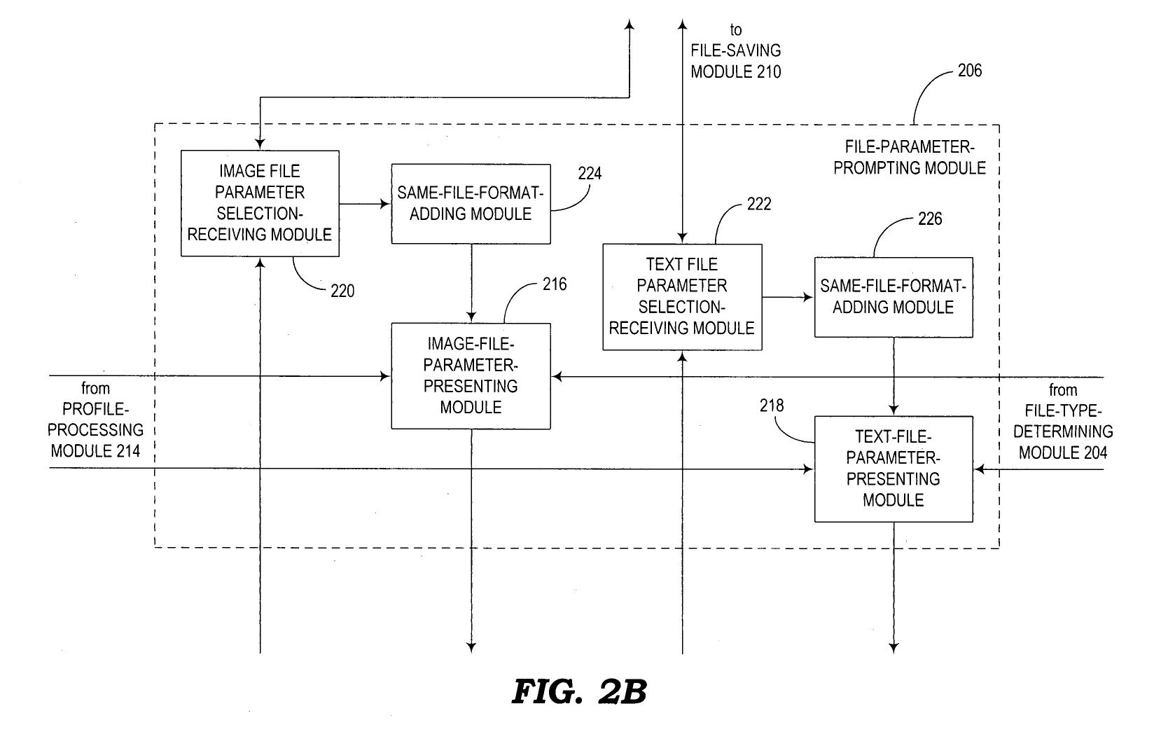

FIGS. 2A-2C are block diagrams of an embodiment of the SAMF system 114. The SAMF system 114 includes a SAMF-request-receiving module 202, which receives a request from a user to initiate the file-saving operation in which an active file is saved as multiple files. Upon receipt of a SAMF request, the SAMF-request-receiving module 202 signals a file-type-determining module 204 to determine whether the active file to be saved is an image file or a text file. Based on this determination, the file-type-determining module 204 notifies a file-parameter-prompting module 206 whether the active file is an image file or a text file. The file-type-determining module 204 may be disabled when the SAMF system 114 is incorporated in an application that exclusively processes image files, such as in image editor software.

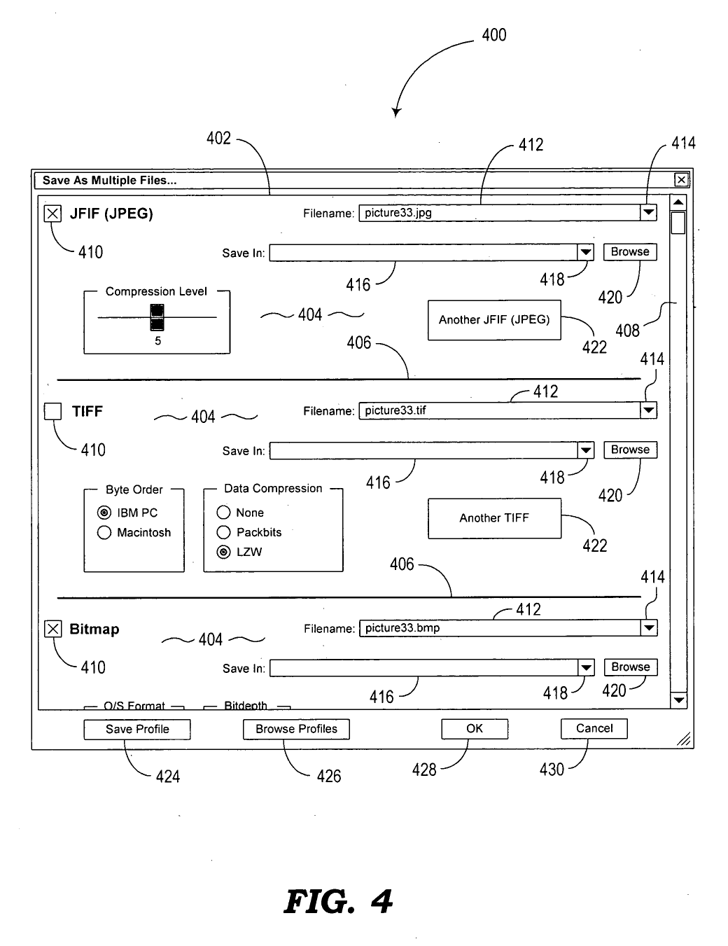

In response to the file-type notification, the file-parameter-prompting module 206 presents either image file parameters or text file parameters on the display device 108 (FIG. 1) to indicate to the user what file parameters are available for selection. The presented file parameters, either image file parameters or text file parameters, are displayed as one or more graphical user interfaces (GUIs) as explained below with respect to FIGS. 4-8. The file-parameter-prompting module 206 then receives the user's selections of the file parameters via the GUIs.

The embodiment of the SAMF system 114 as shown in FIG. 2A further includes a command-accepting module 208, which receives certain commands from the user. If it receives an “Initiate Save” command, then the command-accepting module 208 signals a file-saving module 210 to save the active file as the multiple files in accordance with the selections received by the file-parameter-prompting module 206. If it receives a “Cancel” command, then the command-accepting module 208 initiates a SAMF-canceling module 212 to cancel the file-saving operation and close all related SAMF windows.

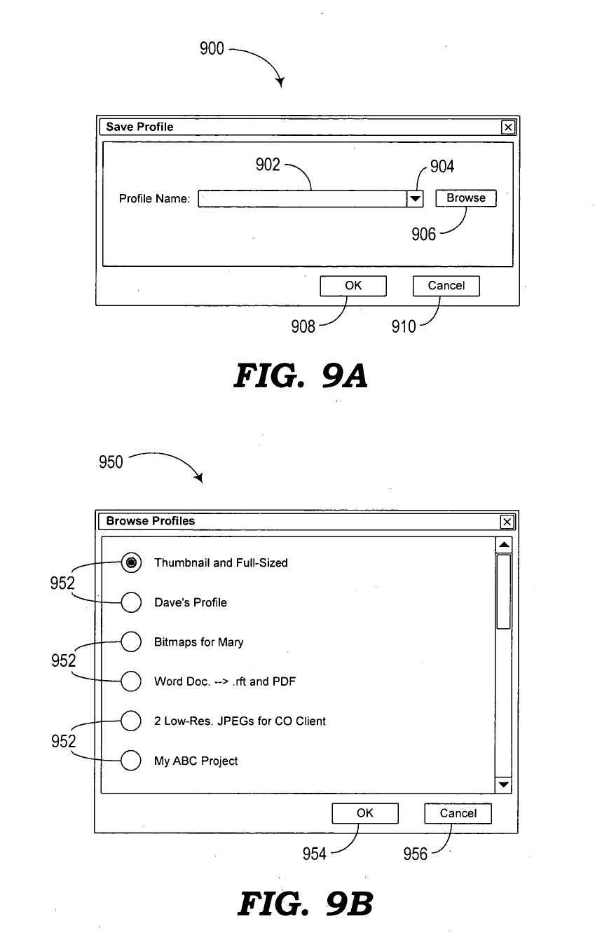

FIG. 2A further illustrates that the SAMF system 114 includes a profile-processing module 214. The profile-processing module 214 receives a command from the user to save the file parameter selections as a profile so that this profile, with all its file parameter selections, can be retrieved during a later SAMF operation. In response to the command to save the profile, the profile-processing module 214 provides a new GUI prompting the user to enter a profile name, as is described in more detail below with respect to FIG. 9A.

Once at least one profile has been saved, the profile-processing module 214 is configured to receive a further request to browse the saved profiles. In response, the profile-processing module 214 provides another GUI prompting the user to select from a list of saved profiles. When a profile selection is made, the profile-processing module 214 instructs the file-parameter-prompting module 206 to incorporate the file parameter selections of the selected profile into the respective file parameter GUI. At this point, the user may review the selections and, if the selections are acceptable, initiate the SAMF operation by sending the “Initiate Save” command to the command-accepting module 208.

FIG. 2B is a block diagram illustrating an embodiment of the file-parameter-prompting module 206 shown in FIG. 2A. In this embodiment, the file-parameter-prompting module 206 includes an image-file-parameter-presenting module 216 and a text-file-parameter-presenting module 218. When the file-type-determining module 204 determines that the active file is an image file, the file-type-determining module 204 prompts the image-file-parameter-presenting module 216 to present the respective GUI of the image file parameters on the display device 108. The image file parameters include the available image file formats in which the active file can be saved as well as other file-saving options for each particular file format. The GUI of the image file parameters further includes input locations for the user's entry of filename and location. For each particular file format, the image file parameters further include file format options for defining how the new file is to be saved with respect to the particular file format. The file format options may include one or more of the following, or other, options: compression level, compression algorithm, color level, color translation, resolution, size, quality, operating system format, and bit depth. For example, when a JFIF (JPEG) file format is selected, the format options may include compression level and may further include color format, quality, operation, compression type or algorithm, resolution, size, color translation, etc.

When the file-type-determining module 204 determines that the active file is a text file, the file-type-determining module 204 prompts the text-file-parameter-presenting module 218 to present a respective GUI of the text file parameters on the display device 108. The text file parameters include the available text file formats in which the active file can be saved as well as other file-saving options. The GUI of the text file parameters further includes input locations for the user's entry of filename and location.

FIG. 2B further illustrates that the file-parameter-prompting module 206 includes an image file parameter selection-receiving module 220, which receives the user's selections of the image file parameters via interfaces on the respective image file parameter GUI. When the text file parameters are presented to the user by the text-file-parameter-presenting module 218, a text file parameter selection-receiving module 222 receives the user's selections of text file parameters via interfaces on the respective text file parameter GUI. In an application that only deals with image files, the modules 218, 222, and 226 related to text files may be omitted or disabled.

In one embodiment, the file-parameter-prompting module 206 further includes module(s) for enabling a user to select another new file with the same image file format (e.g., same-file-format-adding modules 224 and 226). For instance, in response to a user's selection of a particular image file format, the same-file-format-adding module 224 or 226 adds an extra section of image file parameters, thereby enabling a user to select another new file with the same image file format if desired. As described below in more detail, a button 422 (FIG. 4) may be provided to enable the user to add another new file with the same image file format. When button 422 is actuated, same-file-format-adding module 224 or 226 creates another section (e.g., section 404—FIG. 4) for display by the image-file-parameter-presenting module 216.

In this regard, the SAMF system 114 accepts the selection of two or more new files with the same file format. With respect to the text files, the same-file-format-adding module 226 adds another section (e.g., section 404—FIG. 4) of the text file parameters to the text file parameter GUI presented by the text-file-parameter-presenting module 218. This added section enables the user to save the active file as a second or subsequent file of the same text file format if desired.

FIG. 2C is a block diagram of an embodiment of the profile-processing module 214 shown in FIG. 2A. The profile-processing module 214 in this embodiment includes a profile-saving module 228, which receives a command from the user to save file parameter selections as a profile. In response to the command, the profile-saving module 228 provides a profile naming GUI to the user for prompting the user to enter a name for the new profile to be saved. The file parameter selections and corresponding profile name are saved together in a profile memory 230.

The profile-processing module 214 further includes a profile-browsing module 232. When the user sends a command signal to browse the saved profiles, the profile-browsing module 232 receives the command signal and retrieves the saved profiles from the profile memory 230. Then the profile-browsing module 232 provides a GUI displaying a list of the saved profiles from which the user may choose. Upon a user's selection of one of the profiles, the profile-browsing module 232 signals the file-parameter-prompting module 206 to incorporate the file parameter selections from the selected profile into the respective GUI.

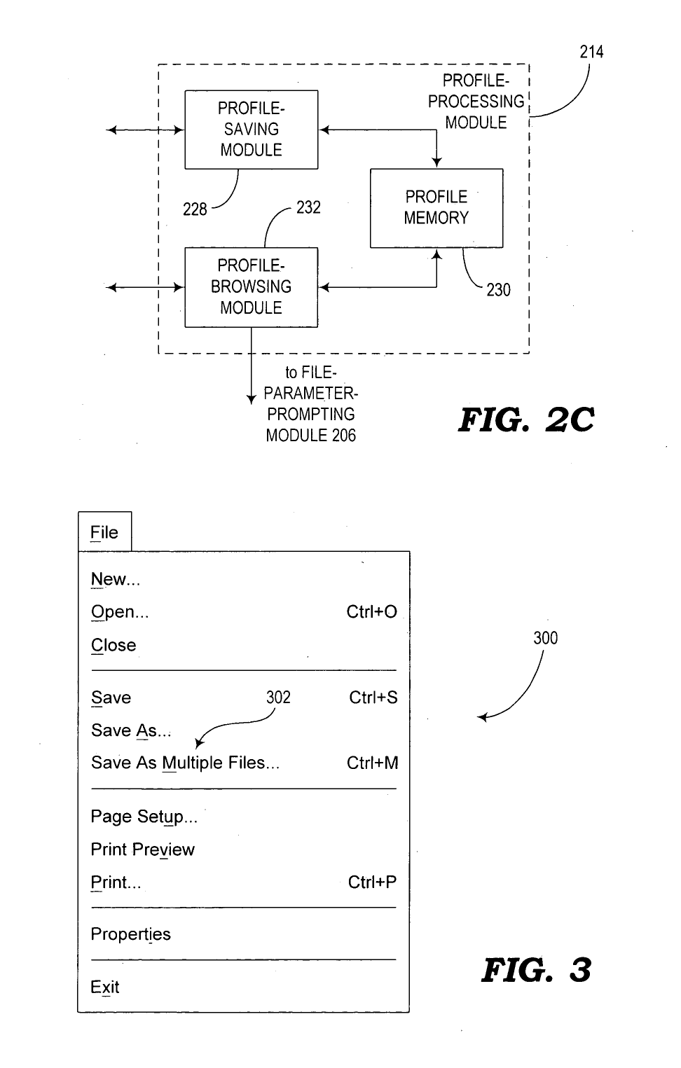

FIG. 3 illustrates an example of an embodiment of a “File” menu 300 that can be opened from application 112 operating in conjunction with the SAMF system 114. In this example, the “File” menu 300 is a drop-down menu, although it could be another suitable menu or function item list, which can be selected by a mouse click on a “File” button in a command toolbar, or by other suitable means for revealing menu items. The “File” menu 300 includes the menu item 302 labeled “Save As Multiple Files . . . ”. By way of an action on one of the input devices 106, such as by a mouse click on the “Save As Multiple Files . . . ” menu item 302, pressing Ctr+M on a keyboard, or other suitable entry action, a signal is sent as a request to the SAMF-request-receiving module 202 (FIG. 2A) to initiate the SAMF system 114 to perform the “Save As Multiple Files” (SAMF) operation.

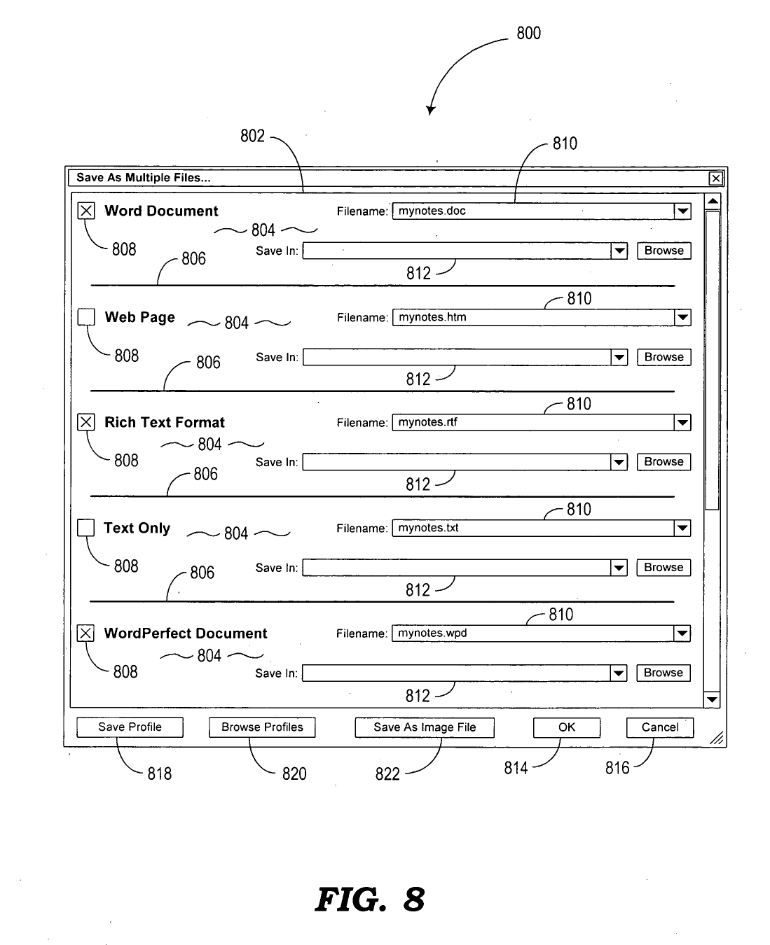

Upon initiation of the SAMF operation, the file-type-determining module 204 (FIG. 2A) determines the file type (e.g., image, text, etc.) and notifies the file-parameter-prompting module 206 to display either an image file parameter GUI, such as one or more of the GUIs shown in FIGS. 4-7, or a text file parameter GUI, such as the one shown in FIG. 8.

FIG. 4 illustrates an example of a GUI 400 that is displayed on the display device 108 in accordance with an embodiment of the SAMF system 114. The GUI 400 includes a pane 402 that shows the available file formats in which a file may be saved and shows available options with respect to each file format. Each available file format, along with its respective options, is displayed respectively within a section 404, which is separated from other file format sections 404 by dividers 406. The pane 402 may include a scrolling mechanism 408 for scrolling through the available file formats and options if the size of all sections 404 is larger than the pane 402 and cannot be displayed within the pane 402 all at one time. Each section 404 includes the name of an available file format, e.g. JFIF (JPEG), and a box 410, or other suitable interface, located next to the file format name for selection of that file format. A file format may be selected using input devices 106, such as by positioning a mouse pointer in the respective box 410 and clicking a mouse button. The SAMF system places an “X” inside the respective box 410 designating that the indicated file format has been selected.

Each section 404 also includes a filename window 412, or other suitable interface, in which a filename can be entered. The SAMF system 114 can provide a default of a filename wherein the name of the active file is provided with the original extension removed and a new extension, based on the type of file format, appended thereto. For example, when saving a file named “picture33.xxx”, the JFIF (JPEG) default may be “picture33.jpg”. A pull down menu of other optional filenames can be accessed by clicking on an arrow 414. Or, if desired, the user may merely type the new filename in the filename window 412 using a keyboard or the like.

Each section 404 further includes a location window 416, or other suitable interface, in which the location where the file is to be saved can be entered, enabling the user to save the file in any selected location. Arrow 418 may be used to pull down available locations or folders. Next to each location window 416 is a browse button 420 that can be selected to help the user navigate through the folder or tree structure of memory 104.

To reiterate, each section 404 includes the file format name, box 410, the filename window 412, and the location window 416 for selecting a respective file format and specifying the filename and location of the new file. In addition, each particular section 404 includes various selectable file format options that are based on the respective file format. For example, with JFIF (JPEG), a compression level is shown as an option that can be adjusted according to the user's needs. In the example shown in FIG. 4, the TIFF format includes different file format options. For example, converting an active file to a TIFF format involves the selection of “Byte Order” options and “Data Compression” options. It should be noted that the file format options shown are merely examples of possible selectable options and may be changed or updated depending on the file format criteria, application 112, etc.

In the third section 404, a Bitmap file format includes other file parameter options, i.e. “O/S Format” and “Bit depth.” Although only a few examples of available file formats are shown in FIG. 4, it should be noted that the scrolling device 408 may be used to reveal additional file formats and their respective options. Other file formats, for example, but not limited to, GIF, PICT, PostScript, etc. may be available. The SAMF system 114, or application 112 that includes the SAMF system 114, may be updated periodically to include new or changed file formats and file format options when they become available or are changed.

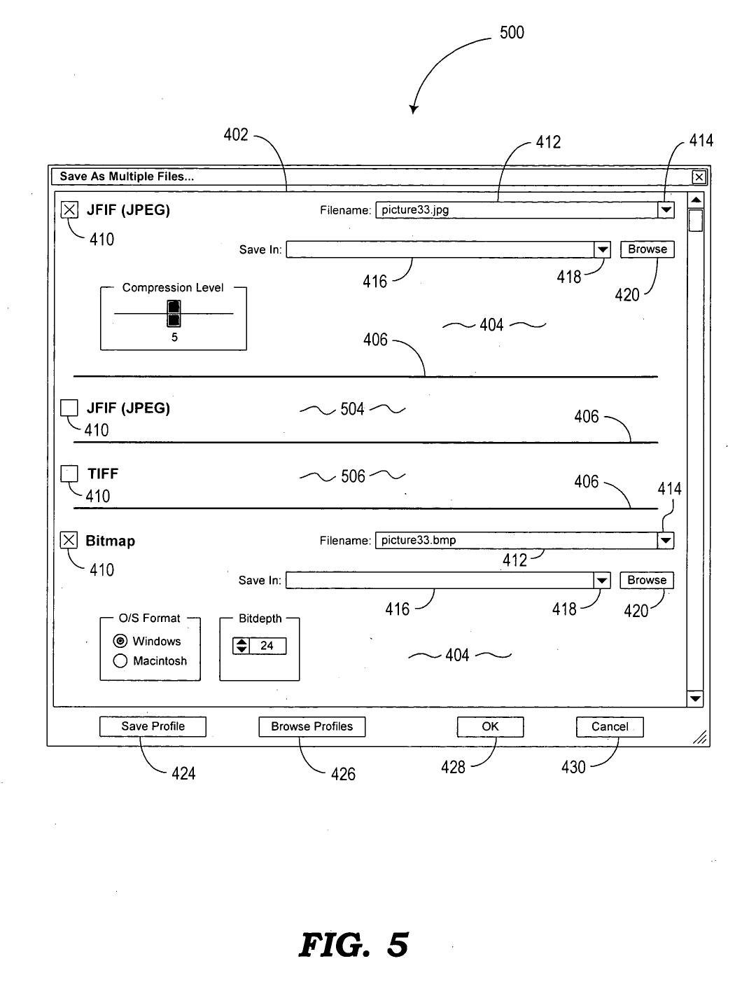

GUI 400 further includes, in each file format section 404, a button 422 for creating another section 404 of the same file format. This button may be used in the situation where the user wishes to save the file as two or more files with the same format. In the JFIF (JPEG) section 404, the button 422 includes the label “Another JFIF (JPEG)” to create another JFIF (JPEG) section 404 enabling another JFIF file to be selected if desired. When button 422 is actuated, the same-file-format-adding module 224 (FIG. 2B) creates a new section for display by the image-file-parameter-presenting module 216. Of course, in this situation where two files have the same format and file extension, the SAMF system 114 preferably creates a different filename default and/or a different location default to avoid duplicity of the same file in the same location. An alternative to button 422 is shown in FIG. 5, as explained in more detail below, where the act of selecting a file format, such as by clicking on box 410, signals the same-file-format-adding module 224 (or 226 in the case of text files) to automatically add a new section 404 of the same file format and corresponding options, enabling a second or subsequent file of the same format to be saved if desired.

The GUI 400 further includes function buttons 424, 426, 428, and 430 that are located outside of pane 402. These function buttons are selected by the user to perform operations in the SAMF system 114 after options are selected. The function buttons are associated with the command-accepting module 208 and the profile-processing module 214 as shown in FIG. 2A, depending on the function selected. When a user has selected all file formats, corresponding file format options to which the active file is to be converted, filenames, and locations where the files are to be saved, then the user may select the “OK” button 428 in order to initiate the save operation. The command-accepting module 208 receives the “OK” or “Initiate Save” command, and in response, signals the file-saving module 210 to convert the active file into the selected file formats according to the selected file format options, name the new files with the new selected filenames, and saves the new files in the selected locations.

If the user decides to cancel the SAMF operation, the user may select the “Cancel” button 430. The command-accepting module 208 receives the cancel command and signals the SAMF-canceling module 212 to cancel the file-saving operation.

Another function button is a “Save Profile” button 424. The Save Profile button 424, in conjunction with the profile-saving module 228 (FIG. 2C), enables a user to save a particular profile of the file parameter selections made in each of the sections 404. When button 424 is selected, the profile-saving module 228 brings up a new GUI, as described in more detail below with respect to FIG. 9A, prompting the user to select a name for the particular profile. It should be noted that, in some but not all embodiments, the filename selection is not saved during the “Save Profile” operation because files saved in subsequent save operations would normally be saved with a different name. Otherwise, providing a default with the same filename may result in the unintentional overwriting of previously saved files. Therefore, the GUI displays a default in the filename window. 412 that corresponds to the filename of the active file, with the extension removed and appropriate new extension appended.

When at least one profile is saved in the profile memory 230, the saved profiles can be retrieved by clicking on a “Browse Profiles” button 426 in the GUI 400 of FIG. 4. The profile-browsing module 232 (FIG. 2C) retrieves the saved profiles from the profile memory 230 and displays a GUI showing the saved profiles, as is described in more detail below with respect to FIG. 9B. When the profile-browsing GUI receives a user's selection of a particular profile, the pane 402 of GUI 400 is changed to display all the selections according to the selected profile. In this regard, the user may more easily enter frequently used selections of file parameters.

FIG. 5 illustrates another example of a GUI 500 that is displayed on the display device 108 in accordance with another embodiment of the SAMF system 114. FIG. 5 includes many similarities to FIG. 4, except that the GUI 500 does not include buttons 422 in each of the sections 404 for creating another of the same respective file format. Instead, FIG. 5 illustrates a feature of the SAMF system 114 in which the same-file-format-adding module 224 is configured to automatically create a new section 504 for another file format of the same type as the selected file format. For example, when a JFIF (JPEG) file format is selected, as is shown in the example of FIG. 5, the same-file-format-adding module 224 creates an additional JFIF (JPEG) section 504 below the first one. Then, the user has the option to select a second or subsequent file of the same format. Therefore, if the user desires to save the active file as two or more JFIF (JPEG), then an additional section 504 of this file format is displayed by the image-file-parameter-presenting module 216 each time a file format is selected.

FIG. 5 also shows another feature that may be incorporated into this, or other, embodiments of the SAMF system 114, in which the image-file-parameter-presenting module 216 initially presents the selectable file formats in a minimized manner as shown in sections 504 and 506, and maintains the minimized sections 504 and 506 until a respective file format is selected. In this way, the minimized sections 504 and 506 take up less space, e.g. only one line. However, when selected, the SAMF system 114 changes a minimized section 504 or 506 to an expanded section 404 in order to display the filename window 412, the location window 416, and the other options available for that particular file format. In another alternative embodiment, the SAMF system 114 greys-out the windows 412 and 416 and file format options of the non-selected file formats thereby reducing the distraction that the non-selected formats take away from the selected formats. When the non-selected sections are greyed-out, the SAMF system 11.4 may make these areas unavailable until the respective file format is actually selected.

The SAMF system 114 may further include means for recording the number of times that a particular file format has been selected in order to display the most-requested file formats as the top sections 404 so that the user can more easily pick these most desired formats. The SAMF system 114 may use other criteria for rearranging the order of the file formats to place “preferred” file formats in the more conspicuous locations. Other defaults can be established based on past selections. For example, the options for each file format can be saved in order that the SAMF system 114 may present defaults of the most commonly selected options, thereby further streamlining the file-saving process.

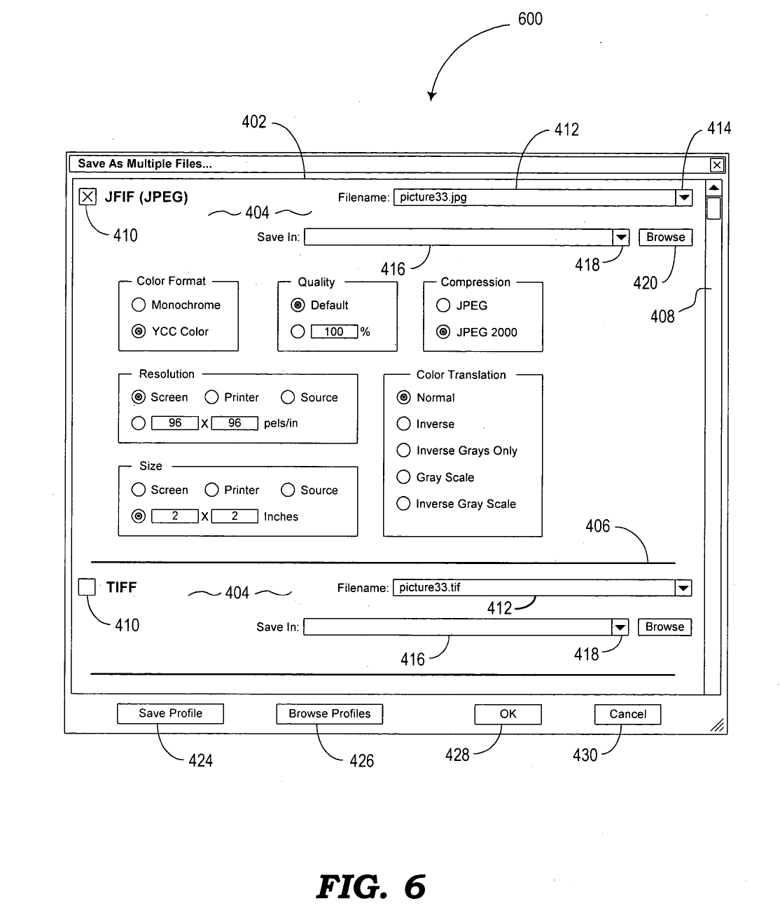

FIG. 6 illustrates another example of a GUI 600 that is displayed on the display device 108 in accordance with another embodiment of the SAMF system 114. FIG. 6 shows other options that may be displayed in the file format sections 404. For example, with JFIF (JPEG), instead of only a compression level to define the saving of the active file, as shown in FIGS. 4 and 5, the SAMF system 114 may provide additional or different file format options. In the embodiment of FIG. 6, the options for the JFIF (JPEG) file format include a color format, quality, compression algorithm, resolution, size, and color translation. The available options may be based on the type of application 112 in memory 104 or on other suitable criteria for sufficiently converting the active file to a new file format.

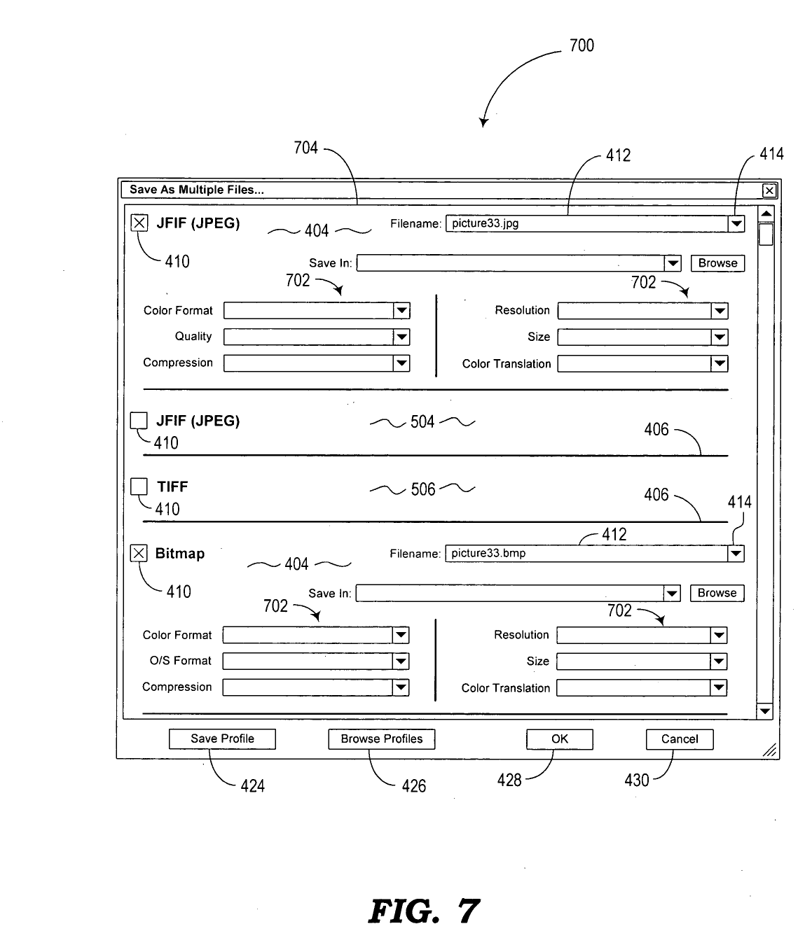

FIG. 7 illustrates another example of a GUI 700 that is displayed on the display device 108 in accordance with another embodiment of the SAMF system 114. In this embodiment, the SAMF system 114 is configured to display file format options in a size-reduced manner. Instead of displaying the expanded option areas as shown in FIG. 6, the GUI 700 of FIG. 7 includes drop down menus 702 for each option, thereby saving space in pane 704. FIGS. 4-7, therefore, show examples of GUIs that are related to the presentation and selection of “image” files.

FIG. 8 illustrates an example of a text file parameter GUI 800 that is displayed on the display device 108 in accordance with another embodiment of the SAMF system 114. In this embodiment, a pane 802 includes text file format sections 804 separated by dividers 806. Alternatively, the sections 804 can be displayed using another configuration to properly show the distinction between the different formats. Each section 804 includes a format name, e.g. “Word Document,” and a selection box 808 for selecting the respective file format. Each section 804 also includes a filename window 810 for entering the filename and a location window 812 for entering the location where the new file is to be saved. Defaults may be presented in these windows to simplify the save process. For example, the extension for the respective file format can be automatically appended at the end of the active filename. The available text formats may include for example, but not limited to, Word Document, Web Page, Rich Text Format, Text Only, etc.

Once the file formats and corresponding filename and location are selected, the user selects the “OK” button 814, which is associated with the command-accepting module 208. In response to the “OK” or “Initiate Save” command, the command-accepting module 208 initiates the file-saving module 210 to save the active file as the multiple files according to the selections made via GUI 800. If the user selects the “Cancel” button 816, the command-accepting module 208 initiates the SAMF-canceling module 212 to cancel the file-saving operation.

The GUI 800 also includes a “Save Profile” button 818 and a “Browse Profiles” button 820, which operate similarly to buttons 424 and 426, respectively, described with respect to FIG. 4. However, with only text file parameters, the saved profiles include only the selections of the file formats and their respective locations. The profile-saving module 228 (FIG. 2C) prompts the user to enter a name of the profile when the Save Profile button 818 is selected. The profile-saving module 228 then saves the profile name and selections in the profile memory 230. When the Browse Profiles button 820 is pressed, the profile-browsing module 232 retrieves the profiles from the profile memory 230 and presents the GUI of saved profiles to the user for selection. When the user selects one of the saved profiles, the SAMF system 114 displays the GUI 800 with the text file selections automatically entered in the appropriate boxes 808 and windows 812 according to the selected profile.

It may be desirable at times for the user to save a text file in an image file format. To meet this need, the GUI 800 includes a “Save As Image File” button 822, located outside the pane 802. By pressing button 822, the SAMF system 114 displays an image file parameter GUI, such as one of the GUIs shown in FIGS. 4-7, which displays all of the available image file formats. In this way, the image of the textual information can then be saved in image form as an image file.

FIG. 9A illustrates an example of a Save Profile GUI 900 in accordance with an embodiment of the SAMF system 114. The GUI 900 prompts the user to enter a name for the profile to be saved. The prompt includes a window 902 where the profile name can be entered. The window 902 further includes an arrow 904 that enables the user to see optional profile name selections. The GUI 900 includes a Browse button 906 that signals the profile-saving module 228 to retrieve the names of previously saved profiles from the profile memory 230 to help the user name the new profile based on previous naming techniques.

The GUI 900 further contains an OK button 908 that, when selected, causes the profile-saving module 228 to save the profile. When saving, the profile-saving module 228 saves, in the profile memory 230, the profile name entered in window 902 along with the file parameters that were selected using a respective file parameter GUI, such as one of the GUIs shown in FIGS. 4-8. After saving the profile, the SAMF system 114 closes the Save Profile GUI 900 and returns to the previous GUI from which file parameters were selected so that the user may proceed with further actions. If a Cancel button 910 is selected, the profile-processing module 214 cancels the profile-saving operation, closes the Save Profile GUI 900, and returns to the previous GUI.

FIG. 9B illustrates an example of a Browse Profiles GUI 950 that may be displayed in accordance with an embodiment of the SAMF system 114. When a user selects the Browse Profiles button 426 (FIGS. 4-7) or button 820 (FIG. 8), a command is sent to the profile-browsing module 232 (FIG. 2C), which retrieves the saved profiles from the profile memory 230 and displays the available profiles on GUI 950. The GUI 950 includes a list of the saved profiles and a selection button 952 next to each listed profile. The selection buttons 952 are configured such that only one button may be selected at once. When one selection button 952 is actuated, this button is later unselected when another selection button 952 is actuated. When the desired profile is selected, the user may press an “OK” button 954 to initiate the profile-browsing module 232 to incorporate the file parameter selections into the respective file parameter GUI in accordance with the selection profile. The SAMF system 114 may be configured such that, when a profile is selected, the file parameters previously selected via the respective GUIs are erased and the selections defined by the selected profile are automatically entered into the interfaces of the GUI. From the GUI 950, the user may select the Cancel button 956, which causes the profile-browsing module 232 to close the Browse Profiles GUI 950 and return to the previous GUI.

1. A system comprising a Save As Multiple Files (SAMF) module configured to save an active file as multiple new files.

2. The system of claim 1, further comprising a SAMF-request-receiving module operative to receive a request to initiate a SAMF operation.

3. The system of claim 1, further comprising a file-type-determining module operative to determine a file format associated with the active file.

4. The system of claim 1, further comprising a file-parameter-prompting module operative to present text file parameters to a user.

5. The system of claim 1, further comprising a file-parameter-prompting module operative to present image file parameters to a user, the image file parameters corresponding to a file format associated with the active file.

6. The system of claim 5, wherein the file-parameter-prompting module comprises an image-file-parameter-presenting module operative to present the image file parameters to the user when the file-type-determining module determines that the active file is an image file.

7. The system of claim 5, wherein a text-file-parameter-presenting module operative to present the text file parameters to the user when the file-type-determining module determines that the active file is a text file.

8. The system of claim 5, wherein an image file parameter selection-receiving module operative to receive the image file parameter selections from the user.

9. The system of claim 5, wherein a text file parameter selection-receiving module operative to receive the text file parameter selections from the user.

10. The system of claim 5, wherein the file-parameter-prompting module comprises:
a same-file-format-adding module operative to add to the image file parameters presented by the image-file-parameter-presenting module additional image file parameters having the same file format as a selected image file format.

11. The system of claim 5, wherein the file-parameter-prompting module further comprises:
a same-file-format-adding module operative to add to the text file parameters presented by the text-file-parameter-presenting module additional text file parameters having the same file format as a selected text file format.

12. The system of claim 5, further comprising a profile-processing module in communication with the file-parameter-prompting module, the profile-processing module comprising a profile-saving module that enables the user to save a profile of the user's file parameter selections on a profile memory that is operative to save a plurality of profiles.

13. The system of claim 1, wherein the SAMF module comprises logic stored in a memory that is executed by a processor.

14. A system comprising means for saving an active file as multiple new files.

15. The system of claim 14, further comprising:
means for prompting a user to select file parameters for the multiple new files.

16. The system of claim 14, further comprising means for determining a file format corresponding to the active file.

17. The system of claim 15, wherein the means for prompting further comprises means for presenting image file parameters when the active file is an image file.

18. The system of claim 15, wherein the means for prompting further comprises means for presenting text file parameters when the active file is a text file.

19. The system of claim 14, further comprising means for prompting a user to select at least one of the following: a file format, a filename, and a location for each of the multiple new files.

20. The system of claim 15, wherein the means for prompting enables the user to select at least two new files with the same file format.

21. The system of claim 14, further comprising means for processing profiles, the means for processing profiles comprising:
means for saving a profile of the user's file parameter; and
means for browsing saved profiles.

22. A graphical user interface (GUI) comprising:
a plurality of sections, each section comprising a selectable file parameter; and
an initiation item for initiating a saving operation in which an active file is saved as multiple new files according to selected file parameters.

23. The GUI of claim 20, wherein the initiation item comprises a button.

24. The GUI of claim 20, wherein each section comprises a file format selection interface.

25. The GUI of claim 20, wherein at least one section is minimized until a respective file format is selected.

26. The GUI of claim 20, wherein at least one section is greyed-out until a respective file format is selected.

27. The GUI of claim 20, wherein, when the active file is an image file, each section comprises file format options related to the respective file format.

28. The GUI of claim 25, wherein the file format options comprise at least one of compression level, compression algorithm, color level, color translation, resolution, size, quality, operating system format, and bit depth.

29. The GUI of claim 20, wherein each section comprises a filename selection interface and a location selection interface.

30. The GUI of claim 27, wherein the filename selection interface displays a default of the filename of the active file with a respective file format extension appended thereto.

31. The GUI of claim 27, wherein the location selection interface further comprises a browse button.

32. The GUI of claim 20, further comprising an image file converting button, wherein, when the active file is a text file, the image file converting button activates the sections to display image file parameters.

33. The GUI of claim 20, further comprising a profile-saving button for saving a profile of selected file parameters.

34. The GUI of claim 20, further comprising a profile-browsing button for browsing a list of saved profiles.
